(19) United States
(12) Patent Application Publication
(10) Pub. No.: US 2022/0157109 A1
(43) Pub. Date: May 19, 2022

(54) SHEET PROCESSING APPARATUS AND FOREIGN OBJECT DETECTION METHOD

(71) Applicant: Glory Ltd., Himeji-shi (JP)

(72) Inventor: Daiki TANAKA, Hyogo (JP)

(73) Assignee: Glory Ltd., Himeji-shi (JP)

(21) Appl. No.: 17/591,606

(22) Filed: Feb. 3, 2022

Related U.S. Application Data
(63) Continuation of application No. PCT/JP2020/030174, filed on Aug. 6, 2020.

(30) Foreign Application Priority Data
Aug. 7, 2019 (JP) 2019-145497

(51) Int. Cl. G07D 11/22; G07D 7/04; G07D 7/181

(52) U.S. Cl. CPC G07D 11/22; G07D 7/181; G07D 7/04

(57) ABSTRACT

A sheet processing apparatus according to an embodiment of the present disclosure includes: a coil that is disposed in a feeding member and configured to produce a magnetic field, the feeding member feeding a inserted sheet to a transport path; and a control circuitry that is configured to evaluate a value based on an impedance of the coil by selecting either a first evaluation criterion or a second evaluation criterion, and, based on an evaluation result, determine presence or absence of a foreign object in the feeding member.

### CROSS-REFERENCE TO RELATED APPLICATIONS

This application is a bypass continuation of International Patent Cooperation Treaty Application No. PCT/JP2020/030174, filed on Aug. 6, 2020, which claims priority to Japanese Patent Application No. 2019-145497, filed on Aug. 7, 2019, the entire disclosures of each are incorporated herein by reference.

### BACKGROUND ART

A metal detection apparatus for money processing apparatus and a money processing apparatus with an excellent performance for detecting a metal piece, such as a coin, vertical to a detection coil have been known.

### SUMMARY OF INVENTION

A sheet processing apparatus, comprising: a coil that is disposed in a feeding member and configured to produce a magnetic field, the feeding member feeding a inserted sheet to a transport path; and a control circuitry that is configured to evaluate a value based on an impedance of the coil by selecting either a first evaluation criterion or a second evaluation criterion, and determine presence or absence of a foreign object in the feeding member, based on an evaluation result.

### BRIEF DESCRIPTION OF DRAWINGS

FIG. 1 illustrates a configuration example of a sheet processing apparatus according to an embodiment;

FIG. 2 illustrates a configuration example of a feeding unit disposed in a depositing unit;

FIG. 3 illustrates an arrangement example of rollers when the feeding unit is viewed from the above;

FIG. 4 illustrates a configuration example of a substrate;

FIG. 5 illustrates a configuration example of a coil;

FIG. 6 is a view when the feeding unit in FIG. 2 is viewed from the direction of an arrow A11;

FIG. 7 illustrates a configuration example of a foreign object detection control system of the sheet processing apparatus;

FIG. 8 illustrates an example of an equivalent circuit of the coil;

FIG. 9 illustrates a block configuration example of a control unit;

FIG. 10 is a timing chart illustrating an operation example of the foreign object detection control system in FIG. 7;

FIG. 11 is a graph for illustrating an example of an impedance change amount in coils with respect to hologram banknotes and coins;

FIG. 12 is a graph for illustrating a first evaluation criterion;

FIG. 13 is a graph for illustrating a second evaluation criterion;

FIG. 14 is a flowchart illustrating an operation example of the control unit during a first mode;

FIG. 15 is a flowchart illustrating an operation example of the control unit during a second mode;

FIG. 16 is a table for illustrating a process example in which a processing unit selects either the first evaluation criterion or the second evaluation criterion, based on a type of banknotes to be processed;

FIG. 17 is a table for illustrating a process example in which the processing unit selects either the first evaluation criterion or the second evaluation criterion, based on an installing location of the sheet processing apparatus; and

FIG. 18 is a graph for illustrating an example of changing a threshold value.

### DESCRIPTION OF EMBODIMENTS

Banknotes comprising metal are circulating in the market. Examples of the banknotes comprising metal include banknotes to which a hologram comprising metal is attached, banknotes to which a metal thread is attached, and the like.

When processing a banknote comprising metal, in some cases, a sheet processing apparatus may misrecognize the banknote comprising metal as a foreign object, which may reduce a detection accuracy of foreign object inclusion.

Accordingly, an object of the present disclosure is to provide a technique for improving the detection accuracy of foreign object inclusion.

In a foreign object detection method according to an embodiment of the present disclosure, a value based on the impedance of a coil that is disposed in a feeding unit and produces a magnetic field, the feeding unit feeding a deposited sheet to a transport path, is evaluated by using either a first evaluation criterion or a second evaluation criterion, and, based on an evaluation result, the presence or absence of a foreign object in the feeding unit is determined.

According to the present disclosure, the detection accuracy of foreign object inclusion can be improved.

Now, an embodiment of the present disclosure will be described below with reference to the drawings. Sheets are not limited to sheets made of paper, but may be sheets made of material other than paper or may be sheets made of paper on which material other than paper is pasted. An example of the material other than paper is resin.

The sheets may further comprise metal. For example, the sheets may be sheets to which a hologram comprising metal is attached. The sheets may also be sheets to which a metal thread is attached.

The following description will be given on the assumption that the sheets are banknotes. However, the sheets are not limited to banknotes, and may be vouchers, securities, ballots, and the like. In addition, the drawings schematically illustrate the respective structural elements for easy understanding. Furthermore, the directions of the arrows in the drawings will be herein described as “up”, “down”, “front”, and “back”, for convenience.

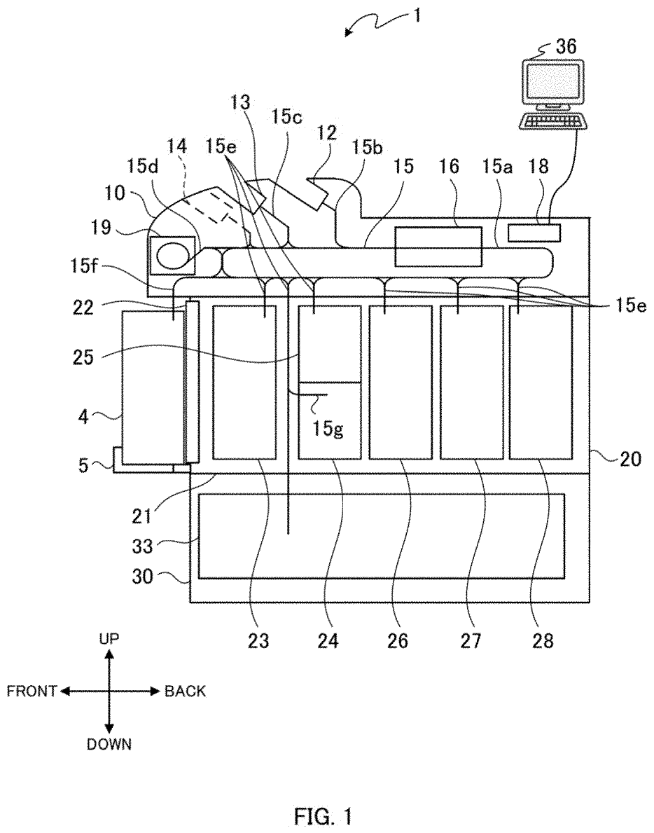

FIG. 1 illustrates a configuration example of a sheet processing apparatus 1 according to the embodiment. FIG. 1 also illustrates an information processing apparatus 36 in addition to the sheet processing apparatus 1. The information processing apparatus 36 may be, for example, a terminal apparatus such as a personal computer.

The sheet processing apparatus 1 may be a banknote depositing and dispensing machine for depositing and dispensing banknotes. The sheet processing apparatus 1 comprises an upper housing 10 and a lower housing 20.

The upper housing 10 comprises, in an upper part, a depositing unit 12 on which banknotes to be deposited are placed, and a dispensing unit 13 on which banknotes to be dispensed are placed. The upper housing 10 further comprises, in an inner part, a transport unit 15 that transports banknotes, a recognition unit 16 that recognizes banknotes, a control unit 18 that controls each unit of the sheet processing apparatus 1, and a temporary storage unit 19 that temporarily stores banknotes. In addition, a second dispensing unit 14 may also be provided adjacently to the dispensing unit 13 as necessary. The configuration of the second dispensing unit 14 may be substantially the same as or different from the configuration of the dispensing unit 13.

A feeding unit that feeds banknotes one by one to the transport unit 15 in a predetermined period is disposed in the depositing unit 12. In addition, a stacking unit that stacks transported banknotes is disposed in the dispensing unit 13.

The transport unit 15 is a transport apparatus that transports banknotes at a predetermined transport speed. The transport unit 15 is constituted of a belt mechanism and a roller mechanism for transporting banknotes. The transport unit 15 comprises a loop-shaped transport path 15a that transports banknotes in a looped manner, a first diverged path 15b, a second diverged path 15c, a third diverged path 15d, fourth diverged paths 15e, and a fifth diverged path 15f that are diverged from the loop-shaped transport path 15a. The first diverged path 15b to the fifth diverged path 15f may be regarded as part of the loop-shaped transport path 15a.

The first diverged path 15b to the fifth diverged path 15f connect the loop-shaped transport path 15a to the depositing unit 12, the dispensing unit 13, the temporary storage unit 19, a first storage 21 or a second storage 30, and a detachable storage unit 4, respectively. The first storage 21, the second storage 30, and the detachable storage unit 4 will be described later. A diverter that diverts banknotes is disposed at a joint between the loop-shaped transport path 15a and each of the first diverged path 15b to the fifth diverged path 15f. In a case where the second dispensing unit 14 is provided, another diverged path that connects the loop-shaped transport path 15a and the second dispensing unit 14 to each other may be provided.

The recognition unit 16 is a recognition unit that reads information of banknotes and recognizes the banknotes. The recognition unit 16 comprises a sensor such as an image sensor, an optical sensor, or a magnetic sensor and recognizes banknote information such as authenticity, domination, fitness, or serial numbers of banknotes transported by the transport unit 15.

A serial number is a unique number given to each banknote and is constituted of, for example, a ten-digit character string including alphabetical letters and numerals in combination. The recognition unit 16 recognizes each of the ten-digit characters constituting the serial number.

The temporary storage unit 19 is a storage unit that temporarily stores banknotes. The temporary storage unit 19 can take in and store banknotes one by one and can feed the stored banknotes one by one.

The temporary storage unit 19 is constituted of, for example, a winding-type storage unit in which a plurality of banknotes are stored by being wound around a rotating body. The temporary storage unit 19 may also be constituted of a stack-type storage unit in which a plurality of banknotes are stored by being stacked.

The control unit 18 is a control apparatus comprising a processing unit such as a central processing unit (CPU) and a memory unit such as a memory. The control unit 18 controls each unit and the detachable storage unit 4 constituting the sheet processing apparatus 1 so that banknotes can be transported between the depositing unit 12, the dispensing unit 13, the temporary storage unit 19, the first storage 21, the second storage 30, and the detachable storage unit 4 via the transport unit 15. The first storage 21, the second storage 30, and the detachable storage unit 4 will be described later.

The lower housing 20 comprises the first storage 21 and the second storage 30 that is disposed below the first storage 21.

The first storage 21 is constituted of, for example, a safe. A storage door 22 that can be locked is disposed on the front surface side of the first storage 21.

In the first storage 21, in order from front to back, a first storage unit 23, a second storage unit 24 and a third storage unit 25 that is disposed above the second storage unit 24, a fourth storage unit 26, a fifth storage unit 27, and a sixth storage unit 28 are arranged. In addition, between the first storage unit 23 and the set of the second storage unit 24 and the third storage unit 25, a fourth diverged path 15e that extends from the loop-shaped transport path 15a to the second storage 30 is disposed.

The fourth diverged paths 15e that are diverged from the loop-shaped transport path 15a are connected to the first storage unit 23 and the third storage unit 25 to the sixth storage unit 28. In addition, a sixth diverged path 15g that is diverged from the fourth diverged path 15e extending from the loop-shaped transport path 15a to the second storage 30 is connected to the second storage unit 24.

The first storage unit 23 to the sixth storage unit 28 are stack-type storage units in which a plurality of banknotes are stored by being stacked. The first storage unit 23 to the sixth storage unit 28 may also be winding-type storage units in which a plurality of banknotes are stored by being wound around a rotating body. Each of the first storage unit 23 to the sixth storage unit 28 stores banknotes that are classified in accordance with a result of recognition by the recognition unit 16.

At the entrance of each of the first storage unit 23 to the sixth storage unit 28, a sensor that detects passing of banknotes is disposed. The sensor is, for example, an optical sensor comprising a light emitting unit that emits light such as infrared light and a light receiving unit that receives the light from the light emitting unit. Note that the sensor may be any type of sensor as long as the sensor can detect storage of banknotes in a corresponding storage unit.

The second storage 30 is constituted of, for example, a safe. In addition, the second storage 30 comprises a collection unit 33 therein. The collection unit 33 comprises a storage area therein, and banknotes to be collected from among banknotes deposited from the depositing unit 12 or banknotes stored in the first storage 21 are stored in the storage area. The collection unit 33 is connected to a fourth diverged path 15e that is diverged from the loop-shaped transport path 15a.

After the banknotes to be collected are stored in the collection unit 33, the banknotes are collected from the collection unit 33 by a collector. Alternatively, after the banknotes to be collected are stored in the collection unit 33, the collection unit 33 is detached from the sheet processing apparatus 1 and collected together with the banknotes by a collector.

The lower housing 20 comprises an attachment unit 5 for attaching the detachable storage unit 4 on an outer surface on the front surface side of the first storage 21. Note that the outer surface of the first storage 21 is an outer surface of the first storage 21 that is accessible without unlocking the locked storage door 22 and is, specifically, an outer surface of the lower housing 20 or an outer surface of the storage door 22.

The attachment unit 5 comprises a fixture that fixes the detachable storage unit 4 attached to the attachment unit 5. The fixture may comprise a locking apparatus.

The attachment unit 5 comprises a terminal for supplying a control signal from the control unit 18 to the detachable storage unit 4. In addition, the detachable storage unit 4 comprises a terminal to be connected to the terminal of the attachment unit 5.

Upon the detachable storage unit 4 being attached to the attachment unit 5, the terminal of the detachable storage unit 4 and the terminal of the attachment unit 5 are directly or indirectly connected to each other. In addition, upon the detachable storage unit 4 being attached to the attachment unit 5, the storage area in the detachable storage unit 4 is connected to the fifth diverged path 15f.

The detachable storage unit 4 is a stack-type storage unit in which a plurality of banknotes are stored by being stacked. The detachable storage unit 4 may also be a winding-type storage unit in which a plurality of banknotes are stored by being wound around a rotating body

The detachable storage unit 4 comprises a driving mechanism constituted of a motor or the like for storing banknotes therein and discharging banknotes to the outside. Alternatively, in a case where the detachable storage unit 4 does not comprise a driving mechanism, the sheet processing apparatus 1 comprises a driving mechanism and transfers a driving force to the detachable storage unit 4 attached to the attachment unit 5.

The information processing apparatus 36 is connected to, for example, the control unit 18. The information processing apparatus 36, for example, accepts an operation of a user and transmits a signal in accordance with the operation of the user to the control unit 18. The control unit 18 may control the sheet processing apparatus 1 in accordance with the signal transmitted from the information processing apparatus 36. The user may include an operator who uses the sheet processing apparatus 1. The user may include a maintenance person who maintains or manages the sheet processing apparatus 1.

The sheet processing apparatus 1 may comprise an input apparatus that accepts an operation of a user. The input apparatus may be, for example, a touch panel or a key-input apparatus comprising a display. The input apparatus transmits a signal in accordance with the operation of the user to the control unit 18. The control unit 18 may control the sheet processing apparatus 1 in accordance with the signal transmitted from the input apparatus.

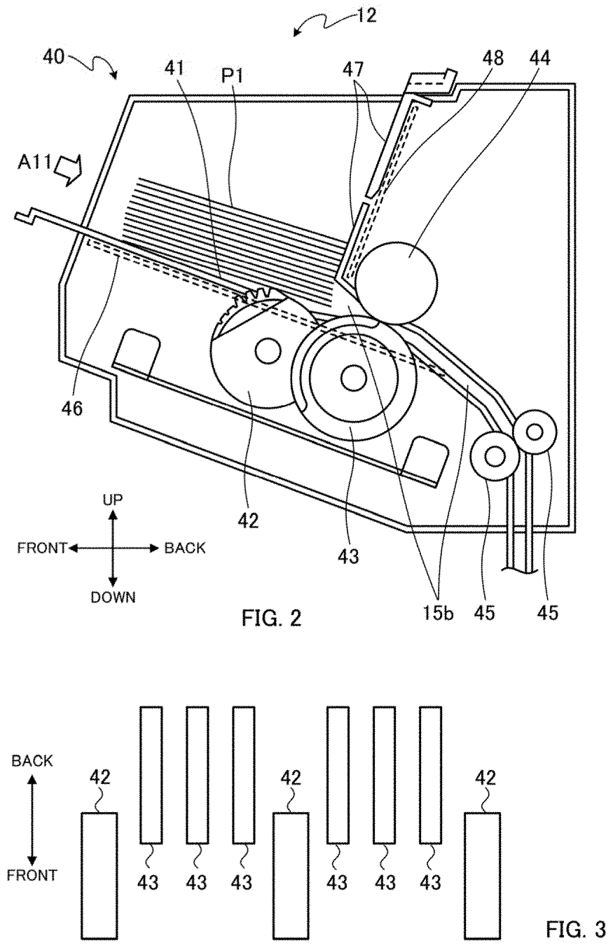

FIG. 2 illustrates a configuration example of a feeding unit 40 disposed in the depositing unit 12. In FIG. 2, the same structural elements as those in FIG. 1 are denoted by the same reference numerals. As illustrated in FIG. 2, the feeding unit 40 comprises a stage 41, kicker rollers 42, feed rollers 43, gate rollers 44, transport rollers 45, a board 46, and a banknote guide 47.

The stage 41 is disposed so as to be connected to the entrance of the first diverged path 15b. The stage 41 is, for example, a flat plate-like member on which banknotes P1 are stacked and placed. Of the banknotes P1 stacked and placed on the stage 41, the lowermost sheet is placed so as to be in contact with a plane of the stage 41. The banknotes P1 placed on the stage 41 are, for example, transported into the first diverged path 15b one by one from the lowermost banknote in response to a deposition operation or the like of a user.

The kicker rollers 42 are arranged below the stage 41 and the board 46 such that part of the outer circumference surfaces thereof protrudes from the stage 41 and the board 46. Openings are formed in the stage 41 and the board 46 so that part of the outer circumference surfaces of the kicker rollers 42 can protrude therefrom.

The kicker rollers 42 rotate clockwise in the drawing. The kicker rollers 42 kick the lowermost banknote of the banknotes P1 placed on the stage 41 toward the first diverged path 15b.

The feed rollers 43 are provided in the vicinity of the entrance of the first diverged path 15b. The vicinity of the entrance of the first diverged path 15b may be regarded as, for example, a portion slightly inside the first diverged path 15b from the entrance of the first diverged path 15b.

The feed rollers 43 are arranged below the first diverged path 15b and the board 46 such that part of the outer circumference surfaces thereof protrudes from the first diverged path 15b and the board 46. Openings are formed in the first diverged path 15b and the board 46 so that part of the outer circumference surfaces of the feed rollers 43 can protrude therefrom.

The feed rollers 43 rotate clockwise in the drawing. The feed rollers 43 transport the lowermost banknote that is kicked by the kicker rollers 42 toward the first diverged path 15b.

The gate rollers 44 are provided so as to face the feed rollers 43 from above the feed rollers 43. The gate rollers 44 are provided such that the outer circumferential surfaces of the gate rollers 44 are in contact with the outer circumferential surfaces of the feed rollers 43. The gate rollers 44 comprise, for example, a one-way clutch, and are rotatable clockwise in the drawing. Thus, banknotes passing between the feed rollers 43 and the gate rollers 44 are transported into the first diverged path 15b one by one.

The transport rollers 45 are provided in the first diverged path 15b. The transport rollers 45 transport banknotes transported from the feed rollers 43 toward the loop-shaped transport path 15a.

The board 46 is disposed below the stage 41 and below the vicinity of the entrance of the first diverged path 15b. In or on the board 46, coils that detect a foreign object are provided. An example of the foreign object is metal. In addition, an example of the foreign object is a coin. The board 46 is disposed below the stage 41 so as to be in contact with or close to the stage 41 so that a foreign object that is included on the stage 41 or in the vicinity of the entrance of the first diverged path 15b can be detected with the coils efficiently. In addition, the board 46 is disposed such that a board surface is parallel to a surface of the stage 41.

FIG. 3 illustrates an arrangement example of rollers when the feeding unit 40 is viewed from the above. In FIG. 3, the same structural elements as those in FIG. 2 are denoted by the same reference numerals. As illustrated in FIG. 3, the feeding unit 40 comprises three kicker rollers 42 and six feed rollers 43. Note that the number of kicker rollers 42 is not limited to three. The number of feed rollers 43 is not limited to six either.

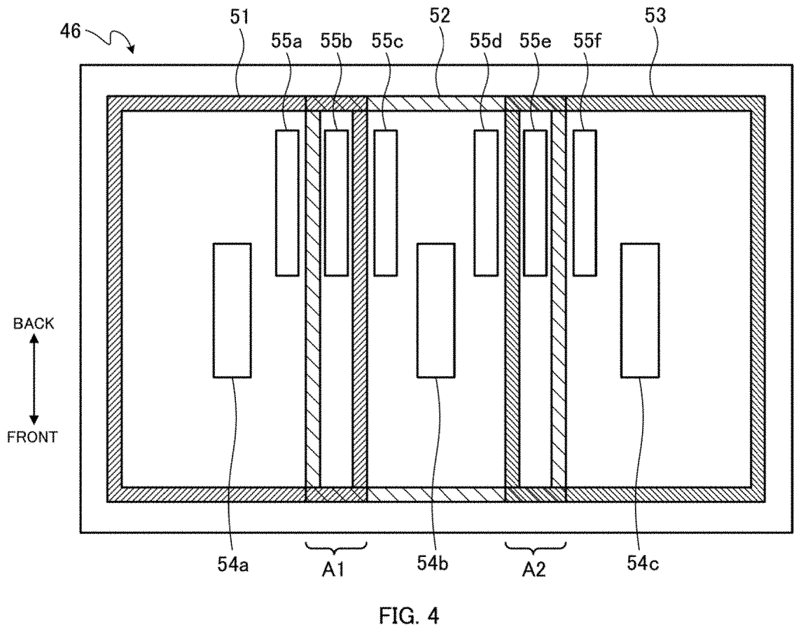

FIG. 4 illustrates a configuration example of the board 46. As illustrated in FIG. 4, the board 46 comprises coils 51 to 53 and openings 54a to 54c and 55a to 55f.

The board 46 is, for example, a multi-layer board. The coils 51 to 53 are formed on a surface or in a predetermined layer of the multi-layer board. The coils 51 to 53 in FIG. 4 are hatched so that the respective coils can be distinguished from one another easily.

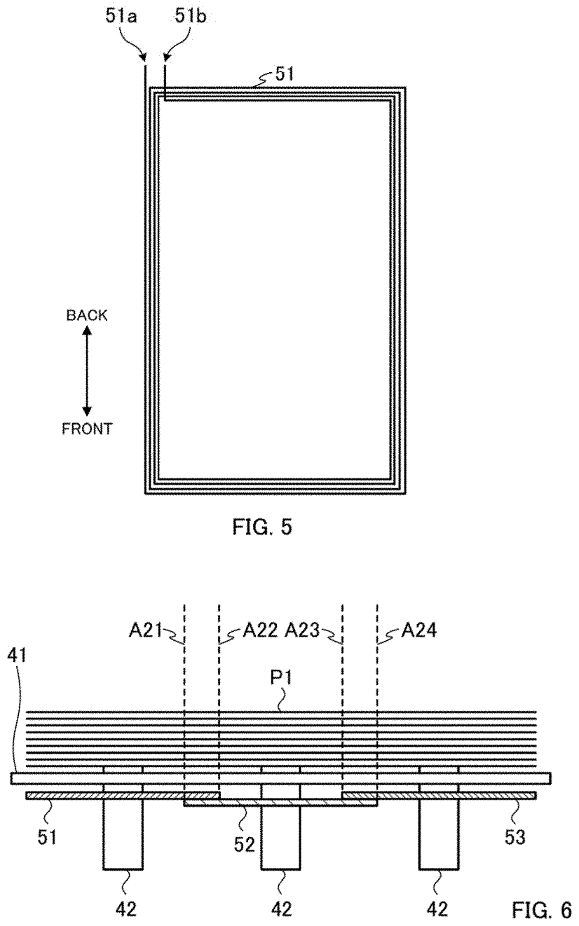

FIG. 5 illustrates a configuration example of the coil 51. As illustrated in FIG. 5, the coil 51 has a square shape and is wound in the shape of a spiral on a plane.

To terminals 51a and 51b of the coil 51 illustrated in FIG. 5, current or voltage is supplied in response to control of the control unit 18. The coil 51 produces a magnetic field by the current or voltage supplied in response to control of the control unit 18.

The coils 52 and 53 have substantially the same shape as the coil 51 and are wound in the shape of a spiral on a plane. The numbers of turns of the coils 51 to 53 are equal. Although the number of turns of the coil 51 is “4” in FIG. 5, the number of turns is not limited thereto.

Referring back to FIG. 4, the coils 51 to 53 produce a magnetic field in response to control of the control unit 18 (supply of current or voltage) as described above. The coils 51 to 53 are wound in the shape of a square spiral on a plane of the board 46, and the magnetic field in the center of the coil 51 is produced so as to vertically penetrate the board 46. The magnetic field in the center of each of the coils 52 and 53 is also produced so as to vertically penetrate the board 46.

As illustrated in FIG. 2, the board 46 is disposed below the stage 41 so as to be in contact with or close to the stage 41. In addition, the board 46 is disposed such that the board surface is in parallel to the surface of the stage 41.

Therefore, the coils 51 to 53 formed in the board 46 are arranged such that coil surfaces are in parallel to the surface of the stage 41 on which the banknotes P1 are placed. Alternatively, the coils 51 to 53 formed in the board 46 are arranged such that coil surfaces are in parallel to surfaces of the banknotes P1 placed on the stage 41.

Thus, the magnetic field of the coils 51 to 53 is produced above the stage 41 and in the vicinity of the entrance of the first diverged path 15b and is produced in a space in which the banknotes P1 are stacked. The space in which the banknotes P1 are stacked may be regarded as, for example, a space of the depositing unit 12 into which the banknotes P1 are to be deposited. That is, the magnetic field of the coils 51 to 53 is produced on the stage 41 and in the vicinity of the entrance of the first diverged path 15b where a foreign object may possibly be included.

The coils 51 to 53 are arranged such that part of the coil 51, part of the coil 52, part of the coil 53, which are adjacent to each other, overlap with each other. The coils 51 to 53 are arranged in a direction that is parallel to the surfaces of the banknotes P1 stacked in the feeding unit 40 or the surface of the stage 41 on which the banknotes P1 are placed and that is vertical to the direction of feeding the banknotes P1 (direction from “front” to “back” in FIG. 4). For example, part of the coil 51 and part of the coil 52, which are adjacent to each other, overlap with each other in an area A1. Part of the coil 52 and part of the coil 53, which are adjacent to each other, overlap with each other in an area A2.

Each of the coils 51 to 53 is provided on or in the board 46 so as to correspond to the arrangement of the kicker rollers 42. For example, the coil 51 corresponds to the kicker roller 42 on the left in FIG. 3. In addition, the coil 52 corresponds to the kicker roller 42 in the middle in FIG. 3. Furthermore, the coil 53 corresponds to the kicker roller 42 on the right in FIG. 3.

The coil surface of each of the coils 51 to 53 may overlap with a corresponding one of the kicker rollers 42 when viewed in the direction vertical to the stage 41, that is, the direction vertical to the coil surface. In addition, each of the coils 51 to 53 may be provided so as to surround a corresponding one of the kicker rollers 42. Furthermore, each of the coils 51 to 53 may be provided on or in the board 46 such that a corresponding one of the kicker rollers 42 is positioned at the center of the coil.

In addition, adjacent two coils among the coils 51 to 53 may correspond to a common feed roller 43. For example, the coil 51 and the coil 52 correspond to the second feed roller from the left in FIG. 3. In addition, the coil 52 and the coil 53 correspond to the second feed roller from the right in FIG. 3. Adjacent two coils may overlap with one feed roller 43 when viewed in the direction vertical to the stage 41, that is, the direction vertical to the coil surface. In addition, adjacent two coils may be provided so as to surround one feed roller 43.

The openings 54a to 54c are openings for part of the outer circumferential surfaces of the three kicker rollers 42 illustrated in FIG. 3 to protrude therefrom. The openings 55a to 55f are openings for part of the outer circumferential surfaces of the six feed rollers 43 illustrated in FIG. 3 to protrude therefrom. By comprising the openings 54a to 54c and 55a to 55f, the board 46 can be arranged below the stage 41 so as to be in contact with or close to the stage 41.

Note that the number of coils provided on or in the board 46 is not limited to three. The number of coils may be one or may be four or more.

FIG. 6 is a view when the feeding unit 40 in FIG. 2 is viewed from the direction of an arrow A11. FIG. 6 illustrates the stage 41 and the kicker rollers 42 illustrated in FIG. 2. FIG. 6 also illustrates the coils 51 to 53 illustrated in FIG. 4.

As illustrated in FIG. 6, the coil surfaces of the coils 51 to 53 are in parallel to the surface of the stage 41. In addition, the coils 51 to 53 are arranged at equal distances (including approximately equal distances) from an accommodating space that accommodates the banknotes P1. The accommodating space is a space defined by the feeding unit 40 and is a space in which the deposited banknotes P1 are stacked.

The coils 51 to 53 are arranged at substantially equal distances from the surface of the stage 41 on which the banknotes P1 are placed. For example, the distance between the coil 51 and the lowermost banknote of the banknotes P1 is equal to the distance between the coil 52 and the lowermost banknote of the banknotes P1. In addition, the distance between the coil 52 and the lowermost banknote of the banknotes P1 is equal to the distance between the coil 53 and the lowermost banknote of the banknotes P1.

Although the thicknesses of the coils 51 to 53 are expressed in FIG. 6 so that the coils 51 to 53 can be distinguished from one another easily, the coils 51 to 53 are actually formed on the surface or in a layer of the board 46 to be extremely thin. For example, the coils 51 to 53 may be formed as a wiring pattern of the board 46. In this case, the board 46 on or in which the coils 51 to 53 are formed is parallel to the surface of the stage 41 on which the banknotes P1 are stacked. In addition, the board 46 on or in which the coils 51 to 53 are formed is parallel to the banknotes P1 stacked on the stage 41.

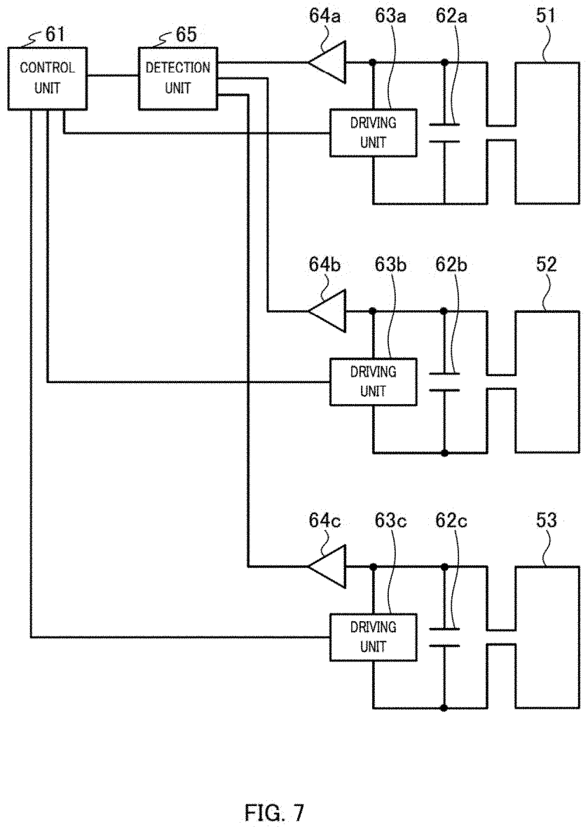

FIG. 7 illustrates a configuration example of a foreign object detection control system of the sheet processing apparatus 1. FIG. 7 illustrates the coils 51 to 53 illustrated in FIG. 4. In FIG. 7, the coils 51 to 53 are simply illustrated and are not partly overlapped. As illustrated in FIG. 7, the foreign object detection control system of the sheet processing apparatus 1 comprises a control unit 61, capacitors 62a to 62c, driving units 63a to 63c, amplifier circuits 64a to 64c, and detection unit 65.

The capacitor 62a and the driving unit 63a are connected in parallel to the coil 51. In response to control of the control unit 61, the driving unit 63a outputs an energization signal for energizing the coil 51 to the coil 51. For example, the driving unit 63a outputs a sine-wave current or voltage to the coil 51.

The coil 51, the capacitor 62a, and the driving unit 63a form a resonance circuit. The frequency of the current or voltage of the driving unit 63a is set to a resonance frequency that is unique to the resonance circuit.

For example, when metal approaches the coil 51 constituting the resonance circuit, an induced current is generated in the metal, and a magnetic flux produced by the coil 51 is changed. As a result, the impedance of the coil 51 is changed. For example, an inductance component and a resistance component of the coil 51 are changed.

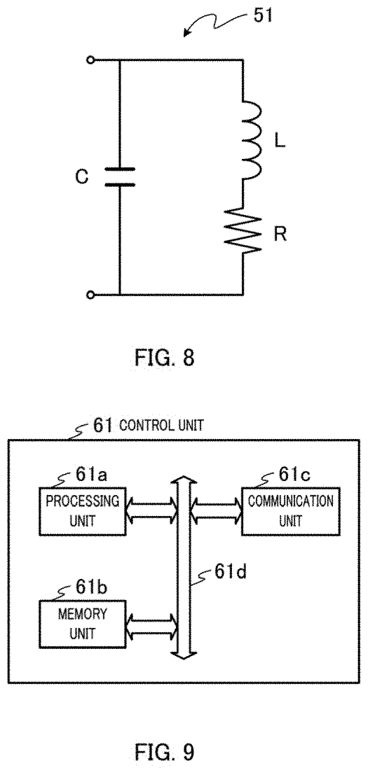

FIG. 8 illustrates an example of an equivalent circuit of the coil 51. As illustrated in FIG. 8, the coil 51 comprises an inductance component L, a resistance component R that is connected in series to the inductance component L, and a parasitic capacitance component C that is connected in parallel to the inductance component L and the resistance component R. For example, the inductance component L and the resistance component R of the coil 51 are changed when the magnetic flux is changed by metal that moves within the magnetic flux. As in the coil 51, the inductance component L and the resistance component R of each of the coils 52 and 53 is changed when the magnetic flux is changed by metal that moves within the magnetic flux.

Referring back to FIG. 7, the amplifier circuit 64a is connected to an end of the coil 51. The amplifier circuit 64a amplifies a signal of the coil 51. The signal of the coil 51 can be regarded as a foreign object detection signal that is output from the coil 51. The signal of the coil 51 may also be referred to as a reception signal. The amplifier circuit 64a outputs the amplified reception signal of the coil 51 to the detection unit 65.

A block of the coil 52, the capacitor 62b, the driving unit 63b, and the amplifier circuit 64b has substantially the same functions as a block of the coil 51, the capacitor 62a, the driving unit 63a, and the amplifier circuit 64a, and description thereof is omitted. A block of the coil 53, the capacitor 62c, the driving unit 63c, and the amplifier circuit 64c has substantially the same functions as the block of the coil 51, the capacitor 62a, the driving unit 63a, and the amplifier circuit 64a, and description thereof is omitted.

From the reception signals of the coils 51 to 53 amplified by the amplifier circuits 64a to 64c, the detection unit 65 detects the values of the impedances of the coils 51 to 53. For example, the detection unit 65 detects the values of the inductance components and the values of the resistance components of the coils 51 to 53. The detection unit 65 outputs the detected values of the impedances of the coils 51 to 53 to the control unit 61. Hereinafter, the value of the impedance may also be simply referred to as the impedance. The value of the inductance component may also be simply referred to as the inductance component. The value of the resistance component may also be simply referred to as the resistance component.

The control unit 61 operates on either of two operation modes, which are a first mode and a second mode. For example, the control unit 61 is switched between the first mode and the second mode in accordance with an instruction from the information processing apparatus 36 or the input apparatus.

The control unit 61 selects either a first evaluation criterion or a second evaluation criterion, evaluates a value based on the impedance of the coil 51 detected by the detection unit 65, and, based on the evaluation result, determines the presence or absence of a foreign object in the feeding unit 40. Alternatively, the control unit 61 selects either the first evaluation criterion or the second evaluation criterion, evaluates at least one of a value based on the inductance component of the detected impedance or a value based on the resistance component of the detected impedance, and, based on the evaluation result, determines the presence or absence of a foreign object in the feeding unit 40. In accordance with the operation mode, the control unit 61 selects either the first evaluation criterion or the second evaluation criterion.

For example, the control unit 61 selects the first evaluation criterion during the first mode. By using the selected first evaluation criterion, the control unit 61 evaluates the value based on the impedance of the coil 51 detected by the detection unit 65 and, based on the evaluation result, determines the presence or absence of a foreign object in the feeding unit 40.

In addition, the control unit 61 selects the second evaluation criterion during the second mode. By using the selected second evaluation criterion, the control unit 61 evaluates the value based on the impedance of the coil 51 detected by the detection unit 65 and, based on the evaluation result, determines the presence or absence of a foreign object in the feeding unit 40.

Similarly, the control unit 61 selects either the first evaluation criterion or the second evaluation criterion in accordance with the operation mode, evaluates the impedance of the coil 52, and, based on the evaluation result, determines the presence or absence of a foreign object in the feeding unit 40. In addition, similarly, the control unit 61 selects either the first evaluation criterion or the second evaluation criterion in accordance with the operation mode, evaluates the impedance of the coil 53, and, based on the evaluation result, determines the presence or absence of a foreign object in the feeding unit 40.

FIG. 9 illustrates a block configuration example of the control unit 61. As illustrated in FIG. 9, the control unit 61 comprises a processing unit 61a, a memory unit 61b, a communication unit 61c, and a bus 61d. The processing unit 61a, the memory unit 61b, and the communication unit 61c are connected to one another via the bus 61d.

The processing unit 61a controls the entirety of the foreign object detection control system. The processing unit 61a may be constituted of, for example, a central processing unit (CPU).

The memory unit 61b stores a program for the processing unit 61a to operate. The memory unit 61b further stores data for the processing unit 61a to perform calculation processing, data for the processing unit 61a to control each unit, and the like. The memory unit 61b may be constituted of a memory apparatus such as a random access memory (RAM), a read-only memory (ROM), a flash memory, or a hard disk drive (HDD).

The communication unit 61c communicates with another unit in the sheet processing apparatus 1 via a network. For example, the communication unit 61c may communicate with sensors that detect passing of banknotes provided in the detachable storage unit 4, the recognition unit 16, the first storage unit 23 to the sixth storage unit 28, and the transport unit 15; the information processing apparatus 36; the driving units 63a to 63c; or the like. The communication unit 61c may also communicate with a server via a network.

Note that the control unit 61 illustrated in FIG. 7 may comprise the detection unit 65 illustrated in FIG. 7. In addition, the detection unit 65 may be constituted of, for example, a field programmable gate array (FPGA). In addition, the functions of the control unit 61 may be implemented by the control unit 18 illustrated in FIG. 1.

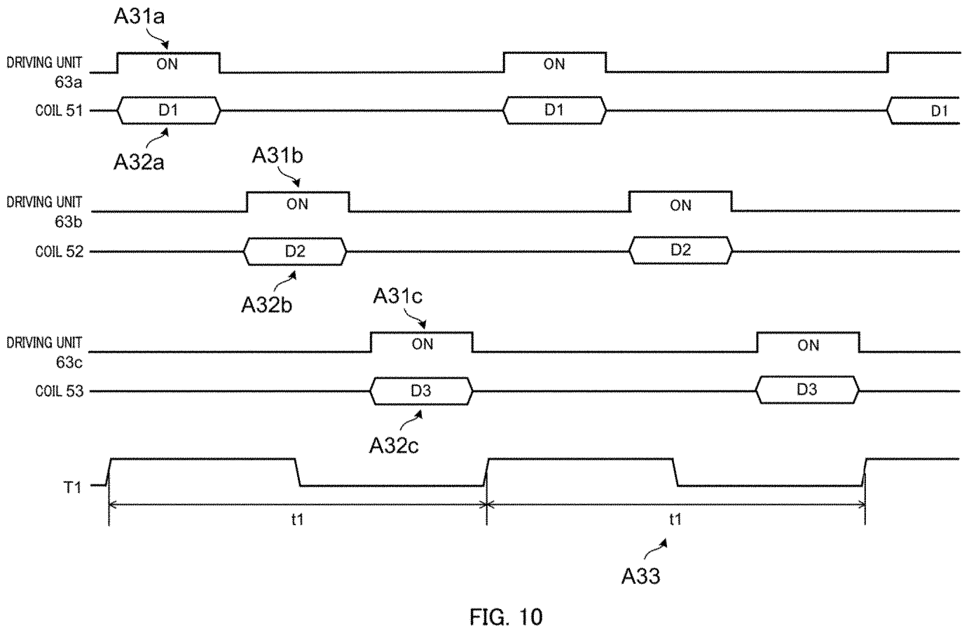

FIG. 10 is a timing chart illustrating an operation example of the foreign object detection control system in FIG. 7. “T1” illustrated in FIG. 10 indicates a timing at which the banknotes P1 stacked on the stage 41 of the feeding unit 40 are fed into the first diverged path 15b one by one. The time taken for one banknote to be fed into the first diverged path 15b is “t1” as illustrated in FIG. 10. In other words, the banknotes P1 stacked on the stage 41 of the feeding unit 40 are fed into the first diverged path 15b one by one in every duration “t1”.

“ON” of the driving units 63a to 63c illustrated in FIG. 10 indicates timings at which the driving units 63a to 63c output energization signals to the coils 51 to 53. During an OFF period other than “ON” illustrated in FIG. 10, the driving units 63a to 63c do not output energization signals to the coils 51 to 53.

“D1” to “D3” of the coils 51 to 53 illustrated in FIG. 10 indicate timings at which the energization signals are input to the coils 51 to 53. In addition, “D1” to “D3” of the coils 51 to 53 illustrated in FIG. 10 indicate timings at which the detection unit 65 detects the impedances of the coils 51 to 53 and outputs the detected impedances of the coils 51 to 53 to the control unit 61.

For example, upon the sheet processing apparatus 1 being powered on, the control unit 61 turns on and off the driving units 63a to 63c one by one. For example, the control unit 61 turns on the driving unit 63a for a certain period as indicated by an arrow A31a in FIG. 10 and then turns off the driving unit 63a. Upon turning off the driving unit 63a, the control unit 61 turns on the driving unit 63b for a certain period as indicated by an arrow A31b and then turns off the driving unit 63b. Upon turning off the driving unit 63b, the control unit 61 turns on the driving unit 63c for a certain period as indicated by an arrow A31c and then turns off the driving unit 63c. Thus, the energization signals are alternately input to the coils 51 to 53 during the duration t1. That is, magnetic fields are sequentially produced from the coils 51 to 53 one by one during the duration t1.

The detection unit 65 monitors the reception signals of the coils 51 to 53 amplified by the amplifier circuits 64a to 64c and detects the impedances of the coils 51 to 53. The detection unit 65 outputs the detected impedances of the coils 51 to 53 to the control unit 61.

For example, the detection unit 65 monitors the reception signal of the coil 51 output from the amplifier circuit 64a at D1 indicated by an arrow A32a in FIG. 10 and detects the impedance of the coil 51. The detection unit 65 outputs the detected impedance of the coil 51 to the control unit 61. In addition, the detection unit 65 monitors the reception signal of the coil 52 output from the amplifier circuit 64b at D2 indicated by an arrow A32b in FIG. 10 and detects the impedance of the coil 52. The detection unit 65 outputs the detected impedance of the coil 52 to the control unit 61. Furthermore, the detection unit 65 monitors the reception signal of the coil 53 output from the amplifier circuit 64c at D3 indicated by an arrow A32c in FIG. 10 and detects the impedance of the coil 53. The detection unit 65 outputs the detected impedance of the coil 53 to the control unit 61.

Upon reception of the impedances of the coils 51 to 53 from the detection unit 65, based on the values based on the received impedances, the control unit 61 determines whether a foreign object is included in the feeding unit 40. For example, the control unit 61 acquires the impedances of the coils 51 to 53 at D1 to D3 indicated by the arrows A32a to A32c in FIG. 10. Subsequently, based on the values based on the acquired impedances of the coils 51 to 53, the control unit 61 determines whether a foreign object is included in the feeding unit 40 during a duration t1 indicated by an arrow A33. That is, upon reception of the impedances of all the coils 51 to 53 from the detection unit 65, the control unit 61 determines whether a foreign object is included in the feeding unit 40 during the duration t1 for feeding the next banknote.

Now, a relationship between the position of a foreign object and an impedance change amount in the coils 51 to 53 will be described with reference to FIG. 6.

The impedance change amount is a change amount depending on the presence or absence of the foreign object in the feeding unit 40. That is, the impedance change amount is a difference between a value of an impedance when the foreign object is absent in an area in which the magnetic flux of any of the coils 51 to 53 is significantly affected and a value of an impedance when the foreign object approaches the area in which the magnetic flux of any of the coils 51 to 53 is significantly affected. Note that an inductance component change amount, which will be described later, is a change amount depending on the presence or absence of the foreign object in the feeding unit 40. That is, the inductance component change amount is a difference between a value of an inductance component when the foreign object is absent in an area in which the magnetic flux of any of the coils 51 to 53 is significantly affected and a value of an inductance component when the foreign object approaches the area in which the magnetic flux of any of the coils 51 to 53 is significantly affected. Similarly, a resistance component change amount, which will be described later, is a change amount depending on the presence or absence of the foreign object in the feeding unit 40. That is, the resistance component change amount is a difference between a value of a resistance component when the foreign object is absent in an area in which the magnetic flux of any of the coils 51 to 53 is significantly affected and a value of a resistance component when the foreign object approaches the area in which the magnetic flux of any of the coils 51 to 53 is significantly affected.

The impedance change amount due to a foreign object such as metal that is present immediately above a wire rod (conducting wire) of any of the coils 51 to 53 is smaller than the impedance change amount due to the foreign object that is present within an area surrounded by the wire rod of any of the coils 51 to 53.

For example, a broken line A21 in FIG. 6 indicates a portion immediately above the wire rod of the coil 52. In a case where a foreign object such as metal is present on the broken line A21, the impedance change amount in the coil 52 is smaller than the impedance change amount due to the foreign object that is present within an area surrounded by the wire rod of the coil 52.

However, as described above, part of the coil 51 and part of the coil 52 overlap with each other. Therefore, the foreign object that is present on the broken line A21 is present immediately above the wire rod of the coil 52 and, at the same time, is present within an area surrounded by the wire rod of the coil 51. Thus, the impedance change amount due to the foreign object that is present on the broken line A21 is regarded as being large in the coil 51.

In addition, for example, a broken line A22 in FIG. 6 indicates a portion immediately above the wire rod of the coil 51. In a case where a foreign object such as metal is present on the broken line A22, the impedance change amount in the coil 51 is smaller than the impedance change amount due to the foreign object that is present within the area surrounded by the wire rod of the coil 51.

However, as described above, part of the coil 51 and part of the coil 52 overlap with each other. Therefore, the foreign object that is present on the broken line A22 is present immediately above the wire rod of the coil 51 and, at the same time, is present within the area surrounded by the wire rod of the coil 52. Thus, the impedance change amount due to the foreign object that is present on the broken line A22 is regarded as being large in the coil 52.

Similarly, a broken line A23 in FIG. 6 indicates a portion immediately above the wire rod of the coil 53. The impedance change amount due to a foreign object that is present on the broken line A23 is regarded as being large in the coil 52. In addition, a broken line A24 in FIG. 6 indicates a portion immediately above the wire rod of the coil 52. The impedance change amount due to a foreign object that is present on the broken line A24 is regarded as being large in the coil 53.

In the above manner, the coils 51 to 53 are provided on or in the board 46 such that part of the coil 51, part of the coil 52, part of the coil 53, which are adjacent to each other, overlap with each other. The control unit 61 controls the driving units 63a to 63c to energize the coils 51 to 53 one by one. Thus, even in a case where a foreign object is present immediately above the wire rod of any one of the coils 51 to 53, a largely changed impedance is output from another coil.

Now, an operation example of the control unit 61 will be described below. First, the first evaluation criterion and the second evaluation criterion will be described. Next, the operation example of the control unit 61 will be described with reference to a flowchart.

Depending on country or the like, hologram banknotes may be circulating in order to prevent counterfeit notes. A hologram banknote is a banknote in which a hologram layer is formed on part of a surface of the banknote made of paper or resin. The hologram layer comprises a metal component, and, for example, a thin film of aluminum or the like or a thin film of a metal oxide is used.

The control unit 61 determines the presence or absence of a foreign object, such as metal, mixed in the feeding unit 40 that feeds banknotes to the inside of the apparatus. For example, the control unit 61 determines the presence or absence of a foreign object, such as a coin, a metal clip, or a metal ornament, mixed in the feeding unit 40.

A hologram banknote comprises a metal component. Thus, in some cases, the control unit 61 may misrecognize the hologram banknote as a foreign object. For example, a value based on the impedance of the hologram banknote may be similar to a value based on the impedance of a small-diameter magnetic coin, and thus, the control unit 61 may misrecognize the hologram banknote as a foreign object.

More specifically, the value based on the impedance of the hologram banknote may be similar to a value based on the impedance of a small-diameter coin whose main component is iron and whose diameter is less than or equal to 20 mm. The same applies to a value based on the inductance component of the impedance or a value based on the resistance component of the impedance. In this case, the control unit 61 may misrecognize the hologram banknote placed in the feeding unit 40 as a foreign object. Note that the value based on the impedance, for example, may be regarded as the above-described impedance change amount or may be regarded as the absolute value of the impedance of a coil when the foreign object approaches the coil. Similarly, the value based on the inductance component, for example, may be regarded as the inductance component change amount or may be regarded as the absolute value of the inductance component of a coil when the foreign object approaches the coil. In addition, the value based on the resistance component, for example, may be regarded as the resistance component change amount or may be regarded as the absolute value of the resistance component of a coil when the foreign object approaches the coil.

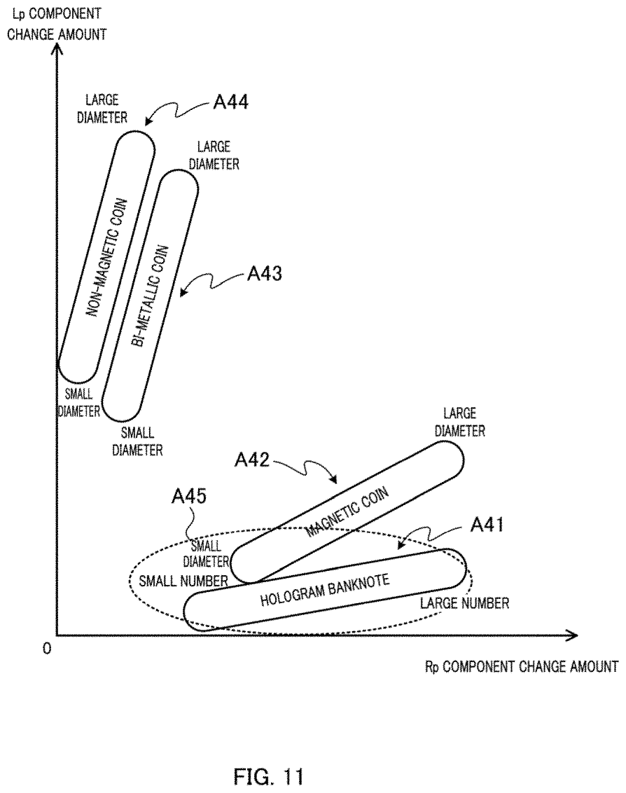

FIG. 11 is a graph for illustrating an example of the impedance change amount in the coils 51 to 53 with respect to hologram banknotes and coins. The horizontal axis of the graph in FIG. 11 represents the resistance component change amount of the impedance in the coils 51 to 53 when a foreign object is present in the feeding unit 40 from when no foreign object is present in the feeding unit 40. The vertical axis of the graph in FIG. 11 represents the inductance component change amount of the impedance in the coils 51 to 53 when a foreign object is present in the feeding unit 40 from when no foreign object is present in the feeding unit 40.

An arrow A41 in FIG. 11 indicates the impedance change amount in accordance with the number of hologram banknotes. For example, as the number of hologram banknotes stacked in the feeding unit 40 increases, as indicated by the arrow A41, the resistance component change amount of the impedance in the coils 51 to 53 and the inductance component change amount of the impedance increase.

An arrow A42 in FIG. 11 indicates the impedance change amount in accordance with the diameter of a magnetic coin. For example, as the diameter of a magnetic coin included in the feeding unit 40 increases, as indicated by the arrow A42, the resistance component change amount of the impedance in the coils 51 to 53 and the inductance component change amount of the impedance increase.

An arrow A43 in FIG. 11 indicates the impedance change amount in accordance with the diameter of a bi-metallic coin. For example, as the diameter of a bi-metallic coin included in the feeding unit 40 increases, as indicated by the arrow A43, the resistance component change amount of the impedance in the coils 51 to 53 and the inductance component change amount of the impedance increase. The bi-metallic coin is, for example, a coin in which a steel is plated with copper.

An arrow A44 in FIG. 11 indicates the impedance change amount in accordance with the diameter of a non-magnetic coin. For example, as the diameter of a non-magnetic coin increases, as indicated by the arrow A44, the resistance component change amount of the impedance in the coils 51 to 53 and the inductance component change amount of the impedance increase. The non-magnetic coin is, for example, a coin made of nickel or the like.

As indicated by a broken line frame A45 in FIG. 11, the impedance of a hologram banknote may be similar to the impedance of a small-diameter magnetic coin. Accordingly, the control unit 61 changes an evaluation criterion of the impedances of the coils 51 to 53 for detecting a foreign object.

For example, in a case where the sheet processing apparatus 1 does not handle hologram banknotes, the control unit 61 evaluates the impedance change amount of the coils 51 to 53 by using the first evaluation criterion and determines the presence or absence of a foreign object. In a case where the sheet processing apparatus 1 handles hologram banknotes, the control unit 61 evaluates the impedance change amount of the coils 51 to 53 by using the second evaluation criterion and determines the presence or absence of a foreign object. The first evaluation criterion and the second evaluation criterion comprise different threshold values (references) for evaluating the impedance change amount.

For example, upon the sheet processing apparatus 1 being powered on, the control unit 61 may acquire the impedances of the coils 51 to 53 in a state where no banknotes and foreign object are present in the feeding unit 40 and may store the impedances in the memory unit 61b. From the impedances output from the detection unit 65 and the impedances stored in the memory unit 61b, the control unit 61 may calculate the resistance component change amount of the impedance in the coils 51 to 53. Alternatively, from the impedances output from the detection unit 65 and the impedances stored in the memory unit 61b, the control unit 61 may calculate the inductance component change amount of the impedance in the coils 51 to 53.

In the following description, the operation mode in which the control unit 61 evaluates the impedance change amount of the coils 51 to 53 by using the first evaluation criterion will be referred to as the first mode. The operation mode in which the control unit 61 evaluates the impedance change amount of the coils 51 to 53 by using the second evaluation criterion will be referred to as the second mode.

The operation mode may be selected by, for example, an operation of a user on the information processing apparatus 36 or the input apparatus. In other words, the first evaluation criterion or the second evaluation criterion may be selected by the user via the information processing apparatus 36 or the input apparatus.

For example, in a case where the sheet processing apparatus 1 does not handle hologram banknotes, the user specifies the first mode on the information processing apparatus 36 or the input apparatus. In other words, in a case where hologram banknotes are not to be processed, the sheet processing apparatus 1 operates on the first mode.

On the other hand, in a case where the sheet processing apparatus 1 handles hologram banknotes, the user specifies the second mode on the information processing apparatus 36 or the input apparatus. In other words, in a case where hologram banknotes are to be processed, the sheet processing apparatus 1 operates on the second mode.

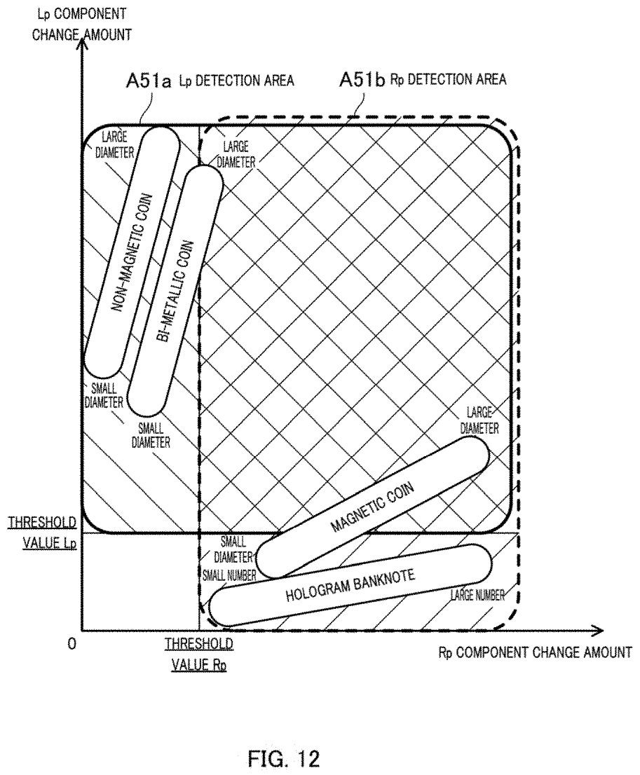

FIG. 12 is a graph for illustrating the first evaluation criterion. FIG. 12 illustrates the graph illustrated in FIG. 11. The control unit 61 operates on the first mode and determines, by using the first evaluation criterion, the presence or absence of a foreign object included in the feeding unit 40.

In a case where the inductance component change amount of the impedance in the coils 51 to 53 is larger than a threshold value Lp (first threshold value), the control unit 61 determines that a foreign object is included in the feeding unit 40. Alternatively, in a case where the resistance component change amount of the impedance in the coils 51 to 53 is larger than a threshold value Rp (second threshold value), the control unit 61 determines that a foreign object is included in the feeding unit 40.

For example, in a case where the inductance component change amount of the impedance in the coils 51 to 53 is included in an Lp detection area indicated by a solid line frame A51a in FIG. 12, the control unit 61 may determine that a foreign object is included in the feeding unit 40. Alternatively, in a case where the resistance component change amount of the impedance in the coils 51 to 53 is included in an Rp detection area indicated by a broken line frame A51b in FIG. 12, the control unit 61 may determine that a foreign object is included in the feeding unit 40.

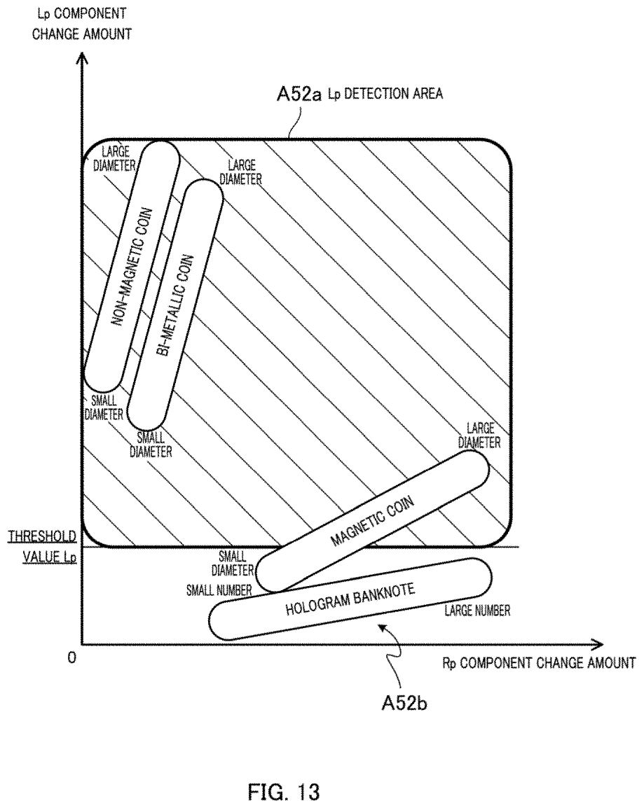

FIG. 13 is a graph for illustrating the second evaluation criterion. FIG. 13 illustrates the graph illustrated in FIG. 11. The control unit 61 operates on the second mode and determines, by using the second evaluation criterion, the presence or absence of a foreign object included in the feeding unit 40.

In a case where the inductance component change amount of the impedance in the coils 51 to 53 is larger than a threshold value Lp (third threshold value), the control unit 61 determines that a foreign object is included in the feeding unit 40.

For example, in a case where the inductance component change amount of the impedance in the coils 51 to 53 is included in an Lp detection area indicated by a solid line frame A52a in FIG. 13, the control unit 61 may determine that a foreign object is included in the feeding unit 40.

During the second mode in which the impedances of the coils 51 to 53 are evaluated by using the second evaluation criterion, the control unit 61 does not determine that hologram banknotes are foreign objects. For example, hologram banknotes indicated by an arrow A52b in FIG. 13 are out of the Lp detection area indicated by the solid line frame A52a in FIG. 13. That is, in a case where the sheet processing apparatus 1 is an apparatus that handles hologram banknotes, the control unit 61 does not misrecognize hologram banknotes as foreign objects.

Note that the control unit 61 does not determine that a small-diameter magnetic coin for which the impedance change amount is similar to that of a hologram banknote is a foreign object during the second mode. For example, the control unit 61 does not determine that a small-diameter magnetic coin out of the frame of the solid line frame A52a in FIG. 13 is a foreign object.

That is, in a case where the sheet processing apparatus 1 does not handle hologram banknotes, the control unit 61 widens an impedance range for determining that a foreign object is present and determines the presence or absence of a small-diameter magnetic coin that is not determined in a case where the range is narrower (second mode). For example, as indicated by the broken line frame A51b in FIG. 12, the impedance range for determining that a foreign object is present is widened, and the presence or absence of a small-diameter magnetic coin that is not determined in a case where the range is narrower is determined.

On the other hand, in a case where the sheet processing apparatus 1 handles hologram banknotes, the control unit 61 narrows the impedance range for determining that a metal foreign object is present to not to misrecognize the presence or absence of a hologram banknote comprising metal. For example, as indicated by the solid line frame A52a in FIG. 13, the impedance range for determining that a metal foreign object is present is narrowed, and the presence or absence of hologram banknotes indicated by the arrow A52b is not misrecognized.

Note that the threshold value Lp (third threshold value) in FIG. 13 may be different from or equal to the threshold value Lp (first threshold value) illustrated in FIG. 12.

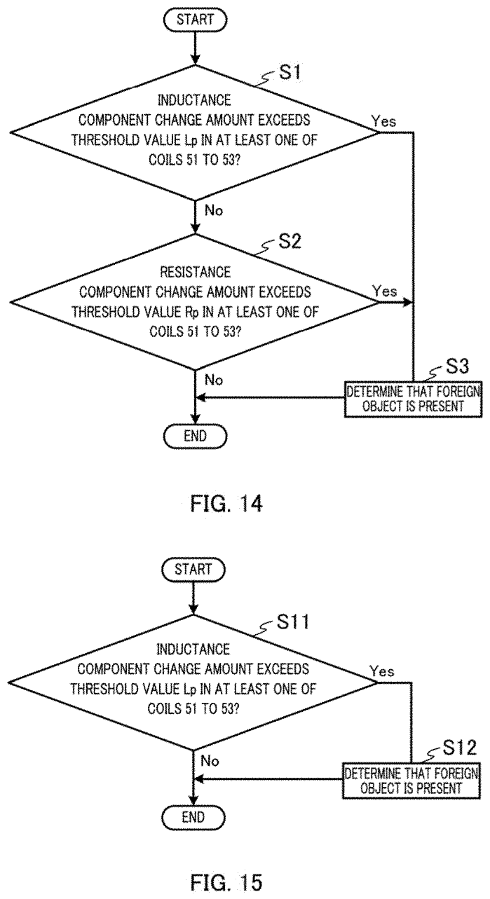

FIG. 14 is a flowchart illustrating an operation example of the control unit 61 during the first mode. The control unit 61 repeats the process in the flowchart in FIG. 14, for example, every time banknotes stacked in the feeding unit 40 are fed to the inside of the apparatus one by one.

The control unit 61 receives the impedances of the coils 51 to 53 from the detection unit 65. The control unit 61 determines whether the inductance component change amount of the impedance exceeds the threshold value Lp in at least one of the coils 51 to 53 (step S1). When the control unit 61 determines that the inductance component change amount of the impedance exceeds the threshold value Lp in at least one of the coils 51 to 53, the process transitions to step S3.

On the other hand, when the control unit 61 determines that the inductance component change amount of the impedance does not exceed the threshold value Lp in at least one of the coils 51 to 53, the control unit 61 determines whether the resistance component change amount of the impedance exceeds the threshold value Rp in at least one of the coils 51 to 53 (step S2). When the control unit 61 determines that the resistance component change amount of the impedance does not exceed the threshold value Rp in at least one of the coils 51 to 53, the process in this flowchart ends.

On the other hand, when the control unit 61 determines that the resistance component change amount of the impedance exceeds the threshold value Rp in at least one of the coils 51 to 53, or determines in step S1 that the inductance component change amount of the impedance exceeds the threshold value Lp in at least one of the coils 51 to 53, the control unit 61 determines that a foreign object is included in the feeding unit 40 (step S3).

Note that the order of steps S1 and S2 may be interchanged. For example, when the control unit 61 determines that the resistance component change amount of the impedance does not exceed the threshold value Rp in at least one of the coils 51 to 53, the control unit 61 may determine whether the inductance component change amount of the impedance exceeds the threshold value Lp in at least one of the coils 51 to 53.

FIG. 15 is a flowchart illustrating an operation example of the control unit 61 during the second mode. The control unit 61 repeats the process in the flowchart in FIG. 15, for example, every time banknotes stacked in the feeding unit 40 are fed to the inside of the apparatus one by one.

The control unit 61 receives the impedances of the coils 51 to 53 from the detection unit 65. The control unit 61 determines whether the inductance component change amount of the impedance exceeds the threshold value Lp in at least one of the coils 51 to 53 (step S11). When the control unit 61 determines that the inductance component change amount of the impedance does not exceed the threshold value Lp in at least one of the coils 51 to 53, the process in this flowchart ends.

On the other hand, when the control unit 61 determines that the inductance component change amount of the impedance exceeds the threshold value Lp in at least one of the coils 51 to 53, the control unit 61 determines that a foreign object is included in the feeding unit 40 (step S12). In the flowcharts in FIG. 14 and FIG. 15, when the control unit 61 determines that a foreign object is included in the feeding unit 40, for example, the foreign object inclusion in the feeding unit 40 may be displayed on an output apparatus such as a display of the information processing apparatus 36 or the sheet processing apparatus 1. In addition, when the control unit 61 determines that a foreign object is included in the feeding unit 40, the feeding unit 40 may stop feeding banknotes. At this time, after the banknotes P1 stacked in the feeding unit 40 are taken out and the foreign object is removed from among the banknotes P1 or from the feeding unit 40, the output apparatus may display a guidance to stack the banknotes P1 in the feeding unit 40 again.

As described above, the sheet processing apparatus 1 comprises: the coils 51 to 53 that are arranged in the feeding unit 40 and produce magnetic fields, the feeding unit 40 feeding deposited sheets to the transport path of the transport unit 15; and the control unit 61 that selects either the first evaluation criterion or the second evaluation criterion, evaluates the values based on the impedances of the coils 51 to 53, and, based on the evaluation result, determines the presence or absence of a foreign object in the feeding unit 40. Thus, the sheet processing apparatus 1 can improve the detection accuracy of foreign object inclusion.

### Variation 1

Although the user specifies the first mode or the second mode as the operation mode in the above description, the present disclosure is not limited thereto. The user may specify a type of banknotes to be processed, and, based on the type of banknotes specified by the user, the control unit 61 may select the first mode or the second mode as the operation mode.

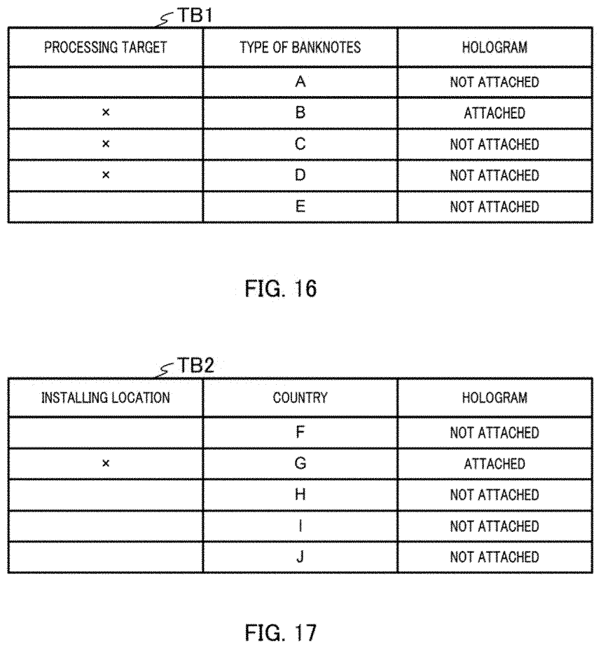

FIG. 16 is a table for illustrating a process example in which the control unit 61 selects either the first evaluation criterion or the second evaluation criterion, based on the type of banknotes to be processed. FIG. 16 illustrates an example of a table TB1 to be stored in the memory unit 61b. “Hologram” in the table TB1 indicates whether a corresponding type of banknotes comprises a hologram. The table TB1 may also be regarded as a setting file.

“Processing Target” in the table TB1 indicates the type of banknotes to be processed by the sheet processing apparatus 1. In a case of the example of the table TB1 in FIG. 16, the sheet processing apparatus 1 processes banknotes of Type B, Type C, and Type D.

“Processing Target” in the table TB1 may be set by a user in the memory unit 61b, for example, when the sheet processing apparatus 1 is installed in a bank or the like. The user can set “Processing Target” in the table TB1 in the memory unit 61b, for example, by operating the information processing apparatus 36 or the input apparatus that the sheet processing apparatus 1 comprises.

The sheet processing apparatus 1 processes banknotes of Type B, Type C, and Type D, for example, in a case where “Processing Target” illustrated in FIG. 16 is set in the table TB1. Banknotes of Type B comprise a hologram. Thus, in a case where “Processing Target” illustrated in FIG. 16 is set in the table TB1, the control unit 61 operates on the second mode. That is, since the type of banknotes to be processed by the sheet processing apparatus 1 comprises hologram banknotes, the control unit 61 operates on the second mode.

In the above manner, the control unit 61 may select either the first evaluation criterion or the second evaluation criterion, based on the type of banknotes to be processed by the sheet processing apparatus 1. Thus, for example, the user may set in the sheet processing apparatus 1, the type of banknotes to be processed by the sheet processing apparatus 1 and does not have to recognize whether banknotes to be processed by the sheet processing apparatus 1 comprise hologram banknotes.

Note that, for example, in a case where Type C, Type D, and Type E are selected as “Processing Target” in the table TB1, the sheet processing apparatus 1 does not handle hologram banknotes. In this case, the control unit 61 operates on the first mode.

### Variation 2

Although the user specifies the type of banknotes to be processed and, based on the type of banknotes specified by the user, the control unit 61 selects the first mode or the second mode as the operation mode in Variation 1, the present disclosure is not limited thereto. The user may specify an installing location of the sheet processing apparatus 1, and, based on the installing location specified by the user, the control unit 61 may select the first mode or the second mode as the operation mode.

FIG. 17 is a table for illustrating a process example in which the control unit 61 selects either the first evaluation criterion or the second evaluation criterion, based on the installing location of the sheet processing apparatus 1. FIG. 17 illustrates an example of a table TB2 to be stored in the memory unit 61b. “Country” in the table TB2 indicates a country in which the sheet processing apparatus 1 is to be installed. “Country” in the table TB2 may be a region in which the sheet processing apparatus 1 is to be installed. “Hologram” in the table TB2 indicates whether hologram banknotes are circulating in a corresponding country. The table TB2 may also be regarded as a setting file.

“Installing Location” in the table TB2 indicates the location in which the sheet processing apparatus 1 is to be installed. In a case of the example of the table TB2 in FIG. 17, the sheet processing apparatus 1 is to be installed in Country G.

“Installing Location” in the table TB2 may be set by a user in the memory unit 61b, for example, when the sheet processing apparatus 1 is installed in a bank or the like. The user can set “Installing Location” in the table TB2 in the memory unit 61b, for example, by operating the information processing apparatus 36 or the input apparatus that the sheet processing apparatus 1 comprises.

The sheet processing apparatus 1 is to be installed in Country G, for example, in a case where “Installing Location” illustrated in FIG. 17 is set in the table TB2. Hologram banknotes are circulating in Country G. Thus, in a case where “Installing Location” illustrated in FIG. 17 is set in the table TB2, the control unit 61 operates on the second mode. That is, since the sheet processing apparatus 1 is to be installed in Country G where hologram banknotes are circulating, the control unit 61 operates on the second mode.

In the above manner, the control unit 61 may select either the first evaluation criterion or the second evaluation criterion, based on the installing location in which the sheet processing apparatus 1 is to be installed. Thus, for example, the user may set in the sheet processing apparatus 1, the installing location of the sheet processing apparatus 1 and does not have to recognize whether banknotes to be processed by the sheet processing apparatus 1 comprise hologram banknotes.

Note that, for example, in a case where Country I is selected as “Installing Location” in the table TB2, the sheet processing apparatus 1 does not handle hologram banknotes. In this case, the control unit 61 operates on the first mode.

### Variation 3

The control unit 61 may change a threshold value to be compared with an impedance depending on characteristics of the impedances of holograms of banknotes to be processed by the sheet processing apparatus 1 and characteristics of the impedances of magnetic coins. Changing of the threshold value may include addition or deletion of the threshold value.

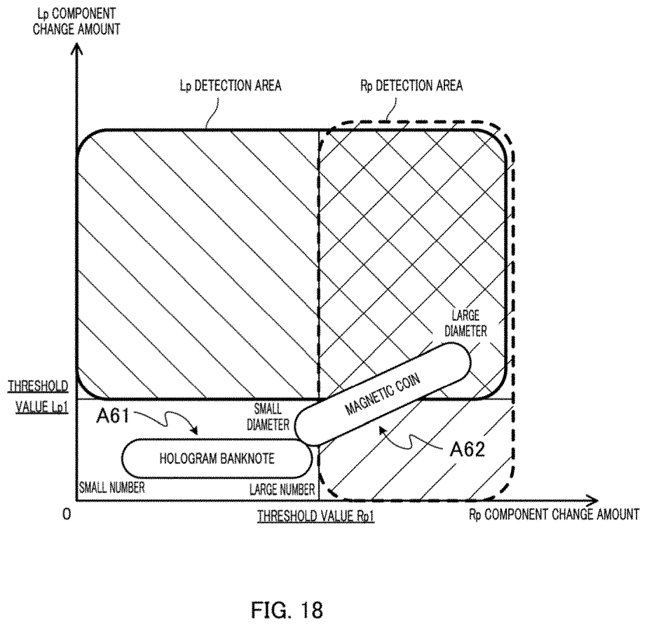

FIG. 18 is a graph for illustrating an example of changing a threshold value. The horizontal axis and the vertical axis illustrated in FIG. 18 are the same as the horizontal axis and the vertical axis of the graph illustrated in FIG. 11. An arrow A61 in FIG. 18 illustrates the impedance change amount in accordance with the number of hologram banknotes. An arrow A62 in FIG. 18 indicates the impedance change amount in accordance with the diameter of a magnetic coin.

As indicated by the arrows A61 and A62 in FIG. 18, in a case where the impedance change amount of hologram banknotes and the impedance change amount of small-diameter magnetic coins differ from the impedance change amount of hologram banknotes and the impedance change amount of small-diameter magnetic coins illustrated in FIG. 13, the control unit 61 may set a threshold value Lp1 and a threshold value Rp1 during the second mode.

For example, in a case where the inductance component change amount of the impedance in the coils 51 to 53 is larger than the threshold value Lp1, the control unit 61 may determine that a foreign object is present in the feeding unit 40. Alternatively, in a case where the resistance component change amount of the impedance in the coils 51 to 53 is larger than the threshold value Rp1, the control unit 61 may determine that a foreign object is present in the feeding unit 40.

That is, in a case where the impedances of hologram banknotes and the impedances of magnetic coins have the characteristics illustrated in FIG. 13, the control unit 61 may determine the presence or absence of a foreign object by using the threshold value Lp. In contrast, in a case where the impedances of hologram banknotes and the impedances of magnetic coins have the characteristics illustrated in FIG. 18, the control unit 61 may determine the presence or absence of a foreign object by using the threshold value Lp1 and the threshold value Rp1.

Although the threshold value in the second evaluation criterion is changed in the above description, the present disclosure is not limited thereto. The control unit 61 may change a threshold value in the first evaluation criterion. The control unit 61 may also change threshold values in both the first evaluation criterion and the second evaluation criterion.

In the above manner, the control unit 61 may change a threshold value in at least either the first evaluation criterion or the second evaluation criterion depending on the characteristics of the impedances of hologram banknotes to be processed by the sheet processing apparatus 1 and the characteristics of the impedances of magnetic coins to be detected as a foreign object.

In addition, the control unit 61 may also change a threshold value in at least either the first evaluation criterion or the second evaluation criterion depending on the domination of banknotes to be processed by the sheet processing apparatus 1.

### Variation 4

Although the second evaluation criterion comprises the threshold value Lp for evaluating the value based on the inductance component of the impedance in FIG. 13, the present disclosure is not limited thereto. The second evaluation criterion may comprise the threshold value Rp for evaluating the value based on the resistance component of the impedance.

### Variation 5

Although hologram banknotes are described as an example of banknotes comprising metal in the above description, the present disclosure is not limited thereto. The present disclosure is also applicable to banknotes comprising a metal thread.

### Variation 6

Although the board 46 is provided below the stage 41, the present disclosure is not limited thereto. For example, the board 46 may also be provided on a back surface of the banknote guide 47 in FIG. 2 (the part indicated by a broken line 48 in FIG. 2).

### Variation 7

The above-described sheet processing apparatus 1 can improve the detection accuracy of foreign object inclusion. However, in a case where banknotes with larger holograms or metal threads are issued, the above-described sheet processing apparatus 1 may possibly misrecognize such a banknote as a foreign object. In addition, due to a sudden change in environment such as temperature, the above-described sheet processing apparatus 1 may also possibly misrecognize a banknote as a foreign object. In a case of misrecognition of a banknote as a foreign object, when the control unit 61 performs control such that the feeding unit 40 stops feeding banknotes, the banknote misrecognized as a foreign object is not fed out. To respond such a situation, the control unit 61 may perform control such that the feeding unit 40 does not stop feeding banknotes even when determining foreign object inclusion. At this time, the output apparatus may continuously display the foreign object inclusion in the feeding unit 40.

When determining the foreign object inclusion, based on a first condition, the control unit 61 may perform control such that the feeding unit 40 does not stop feeding banknotes. The first condition may be reception of a predetermined input signal by the control unit 61 based on an operation of a user. The first condition may also be detection by the control unit 61 that, after the control unit 61 determines that a foreign object is included and performs control such that the feeding unit 40 stops feeding banknotes, the banknotes P1 stacked in the feeding unit 40 are taken out and are then stacked in the feeding unit 40 again. Stacking the banknotes P1 in the feeding unit 40 or taking the banknotes P1 out of the feeding unit 40 can be detected by a sensor provided in the feeding unit 40. The first condition may also be detection by the control unit 61 that the process from determination of foreign object inclusion until re-stacking of the banknotes P1 in the feeding unit 40 is repeated a predetermined number of times. By setting such a first condition, feeding banknotes may be prevented from being stopped only in a case where the possibility of misrecognizing a banknote as a foreign object is high.

In addition, even when determining the foreign object inclusion, after performing control such that the feeding unit 40 does not stop feeding banknotes, based on a second condition, the control unit 61 may perform control such that the feeding unit 40 stops feeding banknotes in a case where a foreign object is included. The second condition may be reception of a predetermined input signal by the control unit 61 based on an operation of a user. The second condition may also be detection by the control unit 61 that, in a state where the control unit 61 determines that no foreign object is included, a predetermined number of banknotes are fed out. By setting such a second condition, original (normal) control can be restored only in a case where the possibility of not misrecognizing a banknote as a foreign object is high.

Although an example of the sheet processing apparatus 1 in which banknotes are horizontally placed is described above, the present disclosure is also applicable to a sheet processing apparatus in which banknotes are vertically placed.

### Variation 8

Although the control unit 61 selects either the first evaluation criterion or the second evaluation criterion in accordance with the operation mode in the above description, the control unit 61 may operate to perform an evaluation by using only the second evaluation criterion. The control unit 61 may also evaluate only either the value based on the inductance component of the impedance in the coils 51 to 53 or the value based on the resistance component of the impedance by using the second evaluation criterion and, based on the evaluation result, may determine the presence or absence of a foreign object in the feeding unit 40. The control unit 61 may also evaluate only the value based on the inductance component of the impedance by using the second evaluation criterion. The second evaluation criterion may be set such that hologram banknotes deposited in a feeding unit disposed in the depositing unit 12 are not recognized as a foreign object. Thus, the control unit 61 does not misrecognize hologram banknotes as a foreign object.

### Reference Signs List

1 Sheet processing apparatus

4 Detachable storage unit

5 Attachment unit

10 Upper housing

12 Depositing unit

13 Dispensing unit

14 Second dispensing unit

15 Transport unit

15a Loop-shaped transport path

15b First diverged path

15c Second diverged path

15d Third diverged path

15e Fourth diverged path

15f Fifth diverged path

15g Sixth diverged path

16 Recognition unit

18, 61 Control unit

19 Temporary storage unit

20 Lower housing

21 First storage

22 Storage door

23 First storage unit

24 Second storage unit

25 Third storage unit

26 Fourth storage unit

27 Fifth storage unit

28 Sixth storage unit

30 Second storage

33 Collection unit

36 Information processing apparatus

40 Feeding unit

41 Stage

42 Kicker roller

43 Feed roller

44 Gate roller

45 Transport roller

46 Board

47 Banknote guide

51 to 53 Coil

54a to 54c, 55a to 55f Opening

61a Processing unit

61b Memory unit

61c Communication unit

61d Bus

1. A sheet processing apparatus, comprising:
a coil that is disposed in a feeding member and configured to produce a magnetic field, the feeding member feeding a inserted sheet to a transport path; and
a control circuitry that is configured to evaluate a value based on an impedance of the coil by selecting either a first evaluation criterion or a second evaluation criterion, and determine presence or absence of a foreign object in the feeding member, based on an evaluation result.

2. The sheet processing apparatus according to claim 1, wherein:
the first evaluation criterion and the second evaluation criterion comprise different threshold values for evaluating the value based on the impedance.

3. The sheet processing apparatus according to claim 1, wherein:
the second evaluation criterion comprises a threshold value for evaluating either a value based on an inductance component of the impedance or a value based on a resistance component of the impedance.

4. The sheet processing apparatus according to claim 1, wherein:
the second evaluation criterion comprises a threshold value for evaluating only a value based on an inductance component of the impedance.

5. The sheet processing apparatus according to claim 1, wherein:
the first evaluation criterion comprises a first threshold value and a second threshold value;
the second evaluation criterion comprises a third threshold value; and
the control circuitry is configured to
(1) determine the presence or absence of the foreign object when a value based on an inductance component of the impedance exceeds the first threshold value or when a value based on a resistance component of the impedance exceeds the second threshold value in a case where the value based on the impedance is evaluated by using the first evaluation criterion, and
(2) determine the presence or absence of the foreign object when a value based on an inductance component of the impedance exceeds the third threshold value in a case where the value based on the impedance is evaluated by using the second evaluation criterion.

6. The sheet processing apparatus according to claim 5, wherein:
the first threshold value and the third threshold value are equal to each other.

7. The sheet processing apparatus according to claim 1, wherein:
the first evaluation criterion and the second evaluation criterion are changed depending on characteristics of metal comprised in the sheet and characteristics of a coin to be detected as the foreign object.

8. The sheet processing apparatus according to claim 1, further comprising
an input apparatus configured to accept selection of either the first evaluation criterion or the second evaluation criterion.

9. The sheet processing apparatus according to claim 1, wherein:
the control circuitry is configured to select either the first evaluation criterion or the second evaluation criterion, based on the sheet to be processed by the sheet processing apparatus.

10. The sheet processing apparatus according to claim 1, wherein:
the control circuitry is configured to select the second evaluation criterion in a case where the sheet comprises metal.

11. The sheet processing apparatus according to claim 1, wherein:
the control circuitry is configured to select either the first evaluation criterion or the second evaluation criterion, based on an installing location in which the sheet processing apparatus is installed.

12. The sheet processing apparatus according to claim 1, wherein:
the value based on the impedance is a change amount of the impedance due to the presence or absence of the foreign object in the feeding member;
a value based on an inductance component of the impedance is a change amount of the inductance component due to the presence or absence of the foreign object in the feeding member; and
a value based on a resistance component of the impedance is a change amount of the resistance component due to the presence or absence of the foreign object in the feeding member.

13. The sheet processing apparatus according to claim 1, wherein:
the value based on the impedance is an absolute value of the impedance in a case where the foreign object is present in the feeding member;
a value based on an inductance component of the impedance is an absolute value of the inductance component in a case where the foreign object is present in the feeding member; and
a value based on a resistance component of the impedance is an absolute value of the resistance component in a case where the foreign object is present in the feeding member.

14. A foreign object detection method, comprising:
evaluating a value based on an impedance of a coil that is disposed in a feeding member and configured to produce a magnetic field, the feeding member feeding a inserted sheet to a transport path, by using either a first evaluation criterion or a second evaluation criterion; and
determining presence or absence of a foreign object in the feeding member, based on an evaluation result.

15. A sheet processing apparatus comprising:
a coil that is disposed in a feeding member and configured to produce a magnetic field, the feeding member feeding a deposited sheet to a transport path; and
a control circuitry that, by using a predetermined evaluation criterion, is configured to evaluate only either a value based on an inductance component of an impedance of the coil or a value based on a resistance component of the impedance, and, based on an evaluation result, determine presence or absence of a foreign object in the feeding member.

16. The sheet processing apparatus according to claim 15, wherein:
the control circuitry is configured to evaluate only the value based on the inductance component of the impedance.

17. The sheet processing apparatus according to claim 15, wherein:
the evaluation criterion comprises a threshold value for evaluating the value based on the inductance component of the impedance; and
the control circuitry is configured to determine that the foreign object is present in a case where the value based on the inductance component of the impedance exceeds the threshold value.

18. The sheet processing apparatus according to claim 15, wherein:
the value based on the inductance component of the impedance is a change amount of the inductance component due to the presence or absence of the foreign object in the feeding member; and
the value based on the resistance component of the impedance is a change amount of the resistance component due to the presence or absence of the foreign object in the feeding member.

19. The sheet processing apparatus according to claim 15, wherein:
the value based on the inductance component of the impedance is an absolute value of the inductance component in a case where the foreign object is present in the feeding member; and
the value based on the resistance component of the impedance is an absolute value of the resistance component in a case where the foreign object is present in the feeding member.

20. The sheet processing apparatus according to claim 15, wherein:
the evaluation criterion is set such that a hologram banknote deposited in the feeding member is not to be determined as the foreign object.
